(19) United States
(12) Patent Application Publication
(10) Pub. No.: US 2025/0276570 A1
(43) Pub. Date: Sep. 4, 2025

(54) STRUCTURE FOR A VEHICLE

(71) Applicants: HYUNDAI MOTOR COMPANY, Seoul (KR); KIA CORPORATION, Seoul (KR)

(72) Inventor: Kyeong Seok Lee, Seoul (KR)

(73) Assignees: HYUNDAI MOTOR COMPANY, Seoul (KR); KIA CORPORATION, Seoul (KR)

(21) Appl. No.: 18/798,401

(22) Filed: Aug. 8, 2024

(30) Foreign Application Priority Data
Mar. 4, 2024 (KR) 10-2024-0030816

(51) Int. Cl. B60K 1/04; B62D 21/02; B62D 25/20

(52) U.S. Cl. CPC B60K 1/04; B62D 21/02; B62D 25/20; B60K 2001/0438

(57) ABSTRACT

A structure for a vehicle includes a battery part having a battery, a floor panel provided above the battery part, a vehicle body member provided above the floor panel, a reinforcement member facing one surface of the floor panel, and a fastening part having one side penetrating the battery part and another side penetrating the reinforcement member.

### CROSS-REFERENCE TO RELATED APPLICATION

This application claims priority to and the benefit of Korean Patent Application No. 10-2024-0030816 filed in the Korean Intellectual Property Office on Mar. 4, 2024, the entire contents of which are incorporated herein by reference.

### TECHNICAL FIELD

The present disclosure relates to a structure for a vehicle, and more particularly, to a structure, which is capable of being applied to a vehicle including a battery.

### BACKGROUND ART

Because an electric vehicle needs to be equipped with a high-capacity battery, it is necessary to ensure a large space in the electric vehicle so that the battery may be mounted and accommodated in the space. In most cases, the battery of the electric vehicle is disposed in a lower space of a passenger compartment of the vehicle. In this case, it is necessary to enhance connectivity between the battery and a vehicle body to stably fix the battery in the electric vehicle. To this end, in the related art, a cross member, which is provided in a lower region of a vehicle body, and a cross member, which is provided on a battery pack, are connected by an intermediate component to improve overall durability of an electric vehicle.

However, because not only the battery but also other components, such as a seat rail, are fixedly coupled to the vehicle body of the electric vehicle, there is a problem in that a region in which the battery and the vehicle body may be coupled to each other is restrictive. A configuration in which a separate vehicle body component is provided for coupling the battery may also be considered. However, the components, which exhibit similar functions, are redundantly provided in the electric vehicle, which is inefficient in terms of spatial utilization and cost.

### SUMMARY

The present disclosure has been made in an effort to provide a structure for a vehicle. The structure may have a configuration for fixing and coupling a battery to a lower portion of a floor panel of a vehicle. A degree to which components, which exhibit similar functions, are redundantly provided may be minimized. A degree of design freedom of the vehicle equipped with the battery is improved and inefficiency is minimized in terms of spatial utilization and cost.

In order to achieve the above-mentioned objects, one aspect of the present disclosure provides a structure for a vehicle. The structure includes: a battery part having a battery; a floor panel for a vehicle provided above the battery part; a vehicle body member provided above the floor panel; a reinforcement member facing one surface of the floor panel; and a fastening part having one side fixed to the battery part, and the other side fixed to the reinforcement member.

The reinforcement member may face a lower surface of the floor panel.

The fastening part may penetrate the floor panel.

The fastening part may include: a pipe member having a shape extending upward toward the floor panel and having one side penetrating the battery part; a bolt member inserted into the pipe member and having one end facing the battery part and another end penetrating the reinforcement member; and a nut member fastened to the other end of the bolt member.

The vehicle body member may include a vehicle body cross member having a shape recessed upward when the vehicle body member is viewed from below. The fastening part may face the vehicle body cross member.

The vehicle body member may include a vehicle body cross member having a shape recessed upward when the vehicle body member is viewed from below. The fastening part may be spaced apart from the vehicle body cross member in a horizontal direction.

The floor panel and the reinforcement member may be fixedly coupled directly to each other.

The floor panel, the vehicle body member, and the reinforcement member may be fixedly coupled to one another in at least one region.

The vehicle body member may include a vehicle body cross member having a shape recessed upward when the vehicle body member is viewed from below. The floor panel, the vehicle body member, and the reinforcement member may be fixed to one another in at least one region. The at least one region may be spaced apart, in a horizontal direction, from a section of the vehicle body cross member recessed upward.

The battery part may include a battery cross member provided on an upper surface of the battery part and having a shape protruding upward. The pipe member may be fixedly coupled to the battery cross member.

The reinforcement member may include a recessed section that is recessed downward. The fastening part may penetrate the recessed section of the reinforcement member.

The nut member may penetrate the floor panel and the reinforcement member.

The nut member may be tightly attached to the reinforcement member and spaced apart from the floor panel.

The nut member may be tightly attached to the reinforcement member and the floor panel.

According to the present disclosure, the configuration for fixing and coupling the battery to the lower portion of the floor panel of the vehicle may be additionally provided. The degree to which the components, which exhibit similar functions, are redundantly provided may be minimized. Thus, the degree of design freedom of the vehicle equipped with the battery may be improved and inefficiency in terms of spatial utilization and cost may be minimized.

### BRIEF DESCRIPTION OF THE DRAWINGS

FIG. 1 is a perspective view illustrating a layered structure of the main components of a structure for a vehicle according to an embodiment of the present disclosure.

FIG. 2 is an exploded perspective view of the components illustrated in FIG. 1.

FIG. 3 is a vertical cross-sectional view of a structure for a vehicle according to an embodiment of the present disclosure.

FIG. 4 is a vertical cross-sectional view of a structure for a vehicle according to another embodiment of the present disclosure.

FIG. 5 is a vertical cross-sectional view of a structure for a vehicle according to still another embodiment of the present disclosure.

FIG. 6 is a vertical cross-sectional view of a structure for a vehicle according to yet another embodiment of the present disclosure.

FIG. 7 is a vertical cross-sectional view of a structure for a vehicle according to still yet another embodiment of the present disclosure.

FIG. 8 is a vertical cross-sectional view of a structure for a vehicle according to a further embodiment of the present disclosure.

### DETAILED DESCRIPTION

Hereinafter, a structure for a vehicle according to the present disclosure is described with reference to the drawings. When a component, device, element, or the like of the present disclosure is described as having a purpose or performing an operation, function, or the like, the component, device, or element should be considered herein as being “configured to” meet that purpose or perform that operation or function.

### Structure for a Vehicle

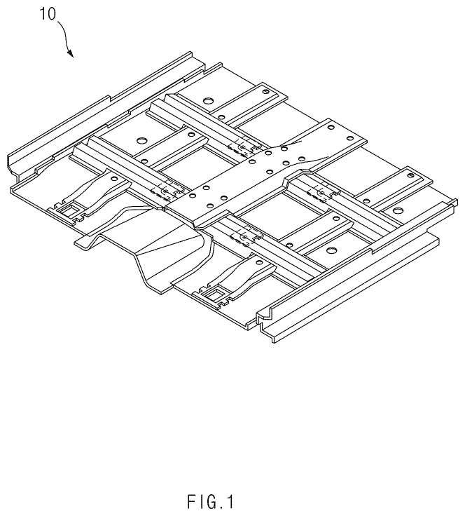

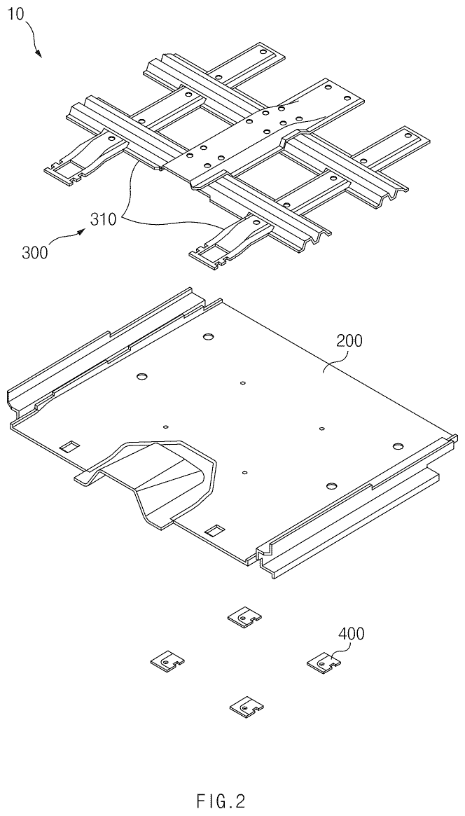

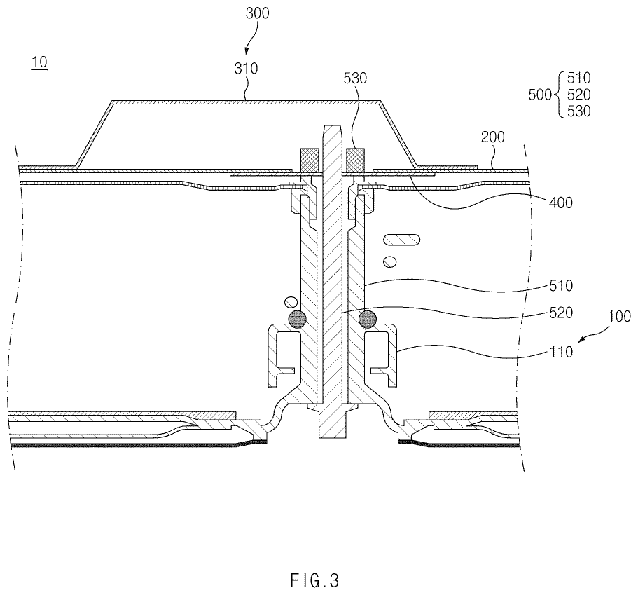

FIG. 1 is a perspective view illustrating a layered structure of the main components of a structure for a vehicle according to an embodiment of the present disclosure. FIG. 2 is an exploded perspective view of the components illustrated in FIG. 1. FIG. 3 is a vertical cross-sectional view of a structure for a vehicle according to an embodiment of the present disclosure.

The structure for a vehicle according to the present disclosure may be applied to a vehicle equipped with a battery. More particularly, the structure for a vehicle according to the present disclosure may be mounted in an electric vehicle.

With reference to FIGS. 1-3, a structure 10 for a vehicle according to the present disclosure may include a battery part 100 inclusive of a battery, a floor panel 200 for a vehicle (hereinafter, referred to as a ‘floor panel’) provided above the battery part 100, and a vehicle body member 300 provided above the floor panel 200. For example, the battery part 100 may be a battery pack. However, the battery part 100 may not be a complete battery pack. For example, the battery part 100 may be a partial component that constitutes the battery pack by being assembled to other components of the vehicle body. Meanwhile, for example, the vehicle body member 300 may have a shape that is open at a lower side thereof.

The structure 10 for a vehicle according to the present disclosure may further include a configuration for fixing the battery part 100 relative to the floor panel 200 and the vehicle body member 300. In other words, the structure 10 for a vehicle may further include a fastening part 500 having one side penetrating the battery part 100 and fixedly coupled to the battery part 100. The fastening part 500 may have a shape extending upward toward the floor panel 200 and the vehicle body member 300.

In this case, the structure 10 for a vehicle according to the present disclosure may further include reinforcement members 400 provided to face one surface of the floor panel 200. The other side of the fastening part 500 may be provided to penetrate the reinforcement member 400.

The reinforcement member 400 may be configured to connect the battery part 100 and the floor panel 200 together with the fastening part 500. In particular, according to the present disclosure, because the fastening part 500 is coupled to the reinforcement member 400 provided separately from the floor panel 200, the battery part 100 may be fixed relative to the floor panel 200 without directly coupling the floor panel 200 and the fastening part 500, unlike the related art. Therefore, according to the present disclosure, it is possible to improve a degree of freedom related to the position at which the fastening part 500 is coupled. Further, because the reinforcement member 400 is additionally provided, the physical rigidity of the structure for a vehicle may be improved in comparison with the related art.

As illustrated in FIGS. 1-3, the reinforcement member 400 may be provided to face a lower surface of the floor panel 200. In other words, based on an upward/downward direction, the floor panel 200 may be provided between the reinforcement member 400 and the vehicle body member 300.

According to the present disclosure, the fastening part 500 may be provided to penetrate the reinforcement member 400 and also penetrate the floor panel 200. However, according to one example of the present disclosure, the reinforcement member 400 may be a component to which the fastening part 500 is substantially coupled. As illustrated in FIG. 3, this configuration may be understood as a configuration in which the fastening part 500 is physically and fixedly coupled to the reinforcement member 400, the fastening part 500 is provided to penetrate the floor panel 200, and the floor panel 200 and the fastening part 500 are not physically and directly coupled to each other in a region in which the fastening part 500 penetrates the floor panel 200.

With continued reference to FIG. 3, the fastening part 500 may include a plurality of members. More specifically, the fastening part 500 may include a pipe member 510 having a shape extending upward toward the floor panel 200 and having one side penetrating the battery part 100. The fastening part 500 may also include a bolt member 520 inserted into the pipe member 510 and having one end provided to face the battery part 100 and the other end penetrating the reinforcement member 400. The fastening part 500 may further include a nut member 530 fastened to the other end of the bolt member 520. For example, as illustrated in FIG. 3, an upper end of the pipe member 510 may be positioned below a lower surface of the reinforcement member 400. This configuration may be understood as a configuration in which the pipe member 510 does not penetrate the reinforcement member 400, unlike the bolt member 520 that penetrates the reinforcement member 400.

With continued reference to FIG. 3, the nut member 530 may be provided to penetrate the floor panel 200 and the reinforcement member 400. In this case, according to the example of the present disclosure, the nut member 530 may be tightly attached to the reinforcement member 400 and physically spaced apart from the floor panel 200. This configuration may be understood as a configuration in which the nut member 530 is coupled directly to the reinforcement member 400 and in which the floor panel 200 is indirectly coupled to the nut member 530 through the reinforcement member 400.

With reference to FIGS. 1-3, the vehicle body member 300 may be a vehicle body cross member 310. Meanwhile, in the present specification, the vehicle body cross members 310 includes, not only a member having a shape extending in a leftward/rightward direction based on the vehicle, but also a member having a shape extending in a forward/rearward direction.

As illustrated in FIGS. 1-3, the vehicle body cross member 310 may have a shape recessed upward. In this case, the fastening part 500 may be provided to face the vehicle body cross member 310. This configuration may be understood as a configuration in which an end of the fastening part 500 positioned in an internal space formed as the vehicle body cross member 310 has a shape recessed upward.

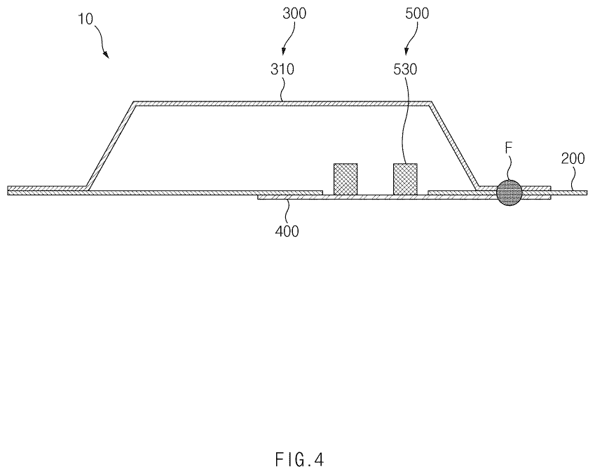

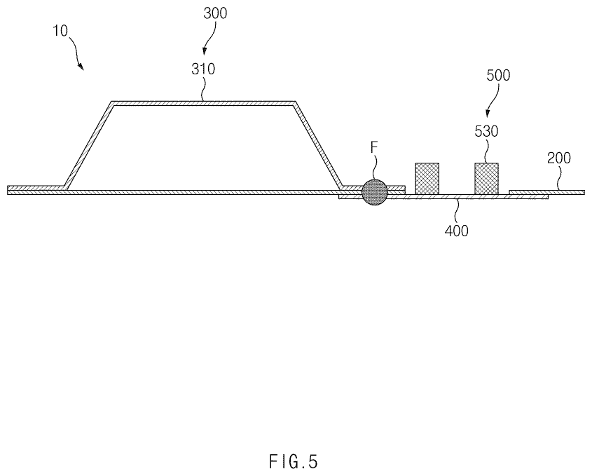

FIG. 4 is a vertical cross-sectional view of a structure for a vehicle according to another embodiment of the present disclosure. FIG. 5 is a vertical cross-sectional view of a structure for a vehicle according to still another embodiment of the present disclosure. In the present specification, the contents mentioned in the above-mentioned embodiment of the present disclosure may also be applied in an intact manner to the contents described below according to another embodiment of the present disclosure and still another embodiment of the present disclosure.

As illustrated in FIGS. 1-4, the fastening part 500 may be provided to face the vehicle body cross member 310. However, as illustrated in FIG. 5, according to another embodiment of the present disclosure, the fastening part 500 may be provided to be spaced apart from the vehicle body cross member 310 in a horizontal direction. This configuration may be understood as a configuration in which the end of the fastening part 500 is spaced apart from the vehicle body cross member 310 without being positioned in the internal space formed as the vehicle body cross member 310 and has a shape recessed upward.

With reference to FIGS. 4 and 5, in the structure 10 for a vehicle according to the present disclosure, the floor panel 200, the vehicle body member (particularly, the vehicle body cross member 310), and the reinforcement member 400 may be fixedly coupled to one another in at least one region F. The one region F may be a region in which the floor panel 200, the vehicle body member 300, and the reinforcement member 400 meet or come together. In the one region F, the floor panel 200, the vehicle body member 300, and the reinforcement member 400 may be fixedly coupled by welding. For example, as illustrated in FIGS. 4 and 5, the floor panel 200, the vehicle body member 300 (particularly, the vehicle body cross member), and the reinforcement member 400 may be fixedly coupled to one another in the at least one region F. Also, the one region F may be spaced apart, in the horizontal direction, from the section of the vehicle body cross member 310 recessed upward.

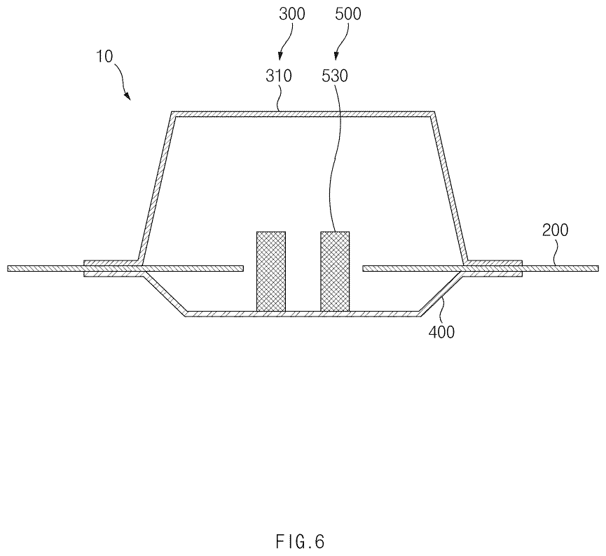

FIG. 6 is a vertical cross-sectional view of a structure for a vehicle according to yet another embodiment of the present disclosure.

With reference to FIGS. 1-5, the reinforcement member 400 may have an approximately flat plate shape. However, as illustrated in FIG. 6, the reinforcement member 400 may include a recessed section having a shape recessed downward. The fastening part 500 may be provided to penetrate the recessed section of the reinforcement member 400. In addition, as illustrated in FIG. 6, at least a partial region of the nut member 530 may be positioned in a space defined by an interval in the upward/downward direction between the recessed section of the reinforcement member 400 and the floor panel 200.

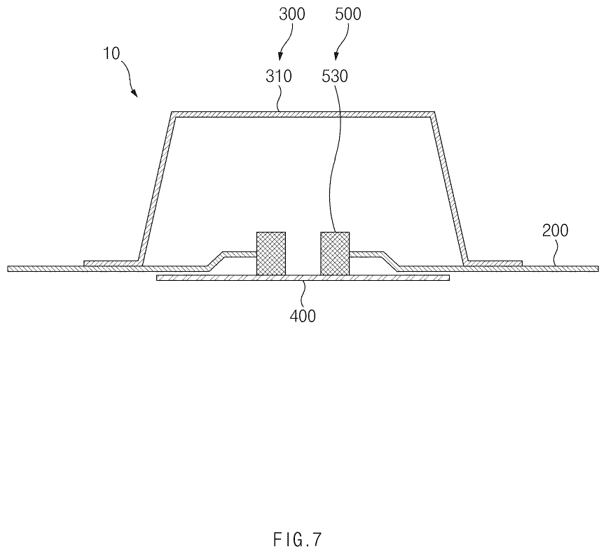

FIG. 7 is a vertical cross-sectional view of a structure for a vehicle according to still yet another embodiment of the present disclosure.

According to the example of the present disclosure described above, the nut member 530 may be provided to penetrate the reinforcement member 400 and the floor panel 200. In this case, as illustrated in FIG. 7, the nut member 530 may be provided to be tightly attached to the floor panel 200 as well as the reinforcement member 400. This configuration may be understood as a configuration in which the nut member 530 is tightly attached to the inner surface of the reinforcement member 400 and the inner surface of the floor panel 200 in the region in which the nut member 530 penetrates the reinforcement member 400 and the floor panel 200.

Meanwhile, according to the present disclosure, the floor panel 200 and the reinforcement member 400 may be fixedly coupled directly to each other. For example, the floor panel 200 and the reinforcement member 400 may be fixedly coupled directly to each other by welding. As another example, the floor panel 200 and the reinforcement member 400 may be coupled to each other by bolt-nut engagement. However, the floor panel 200 and the reinforcement member 400 may not be fixedly coupled directly to each other.

In addition, with reference back to FIG. 3, according to the present disclosure, the battery part 100 may include a battery cross member 110 provided on an upper surface of the battery part 100 and having a shape protruding upward. For example, the battery cross member 110 may be provided on a housing of the battery part 100. In this case, the pipe member 510 of the fastening part 500 may be fixedly coupled to the battery cross member 110. For example, the pipe member 510 and the battery cross member 110 may be fixedly coupled directly to each other by welding. However, the pipe member 510 and the battery cross member 110 may not be fixedly coupled directly to each other. In this case, the pipe member 510 may simply penetrate and pass through the battery cross member 110. Meanwhile, in the present specification, the battery cross member 110 includes, not only a member having a shape extending in the leftward/rightward direction based on the vehicle, but also a member having a shape extending in the forward/rearward direction.

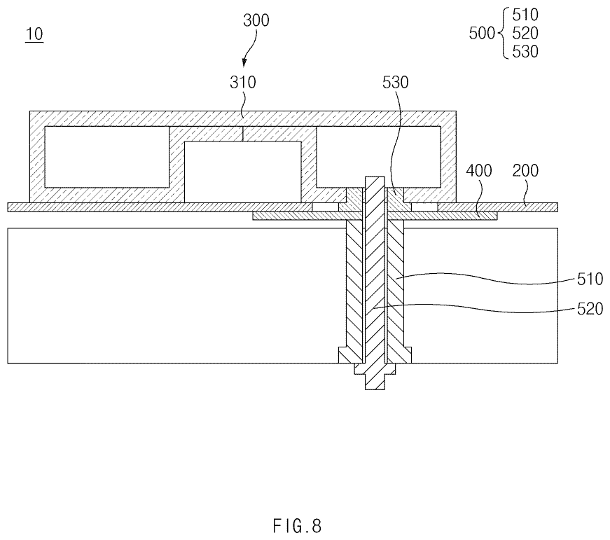

FIG. 8 is a vertical cross-sectional view of a structure for a vehicle according to a further embodiment of the present disclosure.

As illustrated in FIGS. 3-7, the upper surface of the vehicle body cross member 310 of the vehicle body member 300 may have a shape protruding upward. In contrast, as illustrated in FIG. 8, the lower surface of the vehicle body cross member 310 of the vehicle body member 300 may have a shape protruding downward. For example, FIG. 8 illustrates that the upper surface of the vehicle body cross member 310 has a flat shape, whereas the lower surface of the vehicle body cross member 310 has a shape protruding downward. FIG. 8 illustrates that the bolt member 520 is provided to penetrate the reinforcement member 400 and the lower surface of the vehicle body cross member 310. Also, the nut member 530 is fixedly coupled to the lower surface of the vehicle body cross member 310 in the state in which the nut member 530 is tightly attached to the upper surface of the reinforcement member 400. For example, the vehicle body member 300 and the vehicle body cross member 310 illustrated in FIG. 8 may be manufactured by a roll-forming process.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

### DESCRIPTION OF REFERENCE NUMERALS

10: Structure for vehicle
100: Battery part
110: Battery cross member
200: Floor panel
300: Vehicle body member
310: Vehicle body cross member
400: Reinforcement member
500: Fastening part
510: Pipe member
520: Bolt member
530: Nut member

What is claimed is:

1. A structure for a vehicle, the structure comprising:
a battery part including a battery;
a floor panel provided above the battery part;
a vehicle body member above the floor panel;
a reinforcement member facing one surface of the floor panel; and
a fastening part having one side fixed to the battery part and another side fixed to the reinforcement member.

2. The structure of claim 1, wherein the reinforcement member faces a lower surface of the floor panel.

3. The structure of claim 1, wherein the fastening part penetrates the floor panel.

4. The structure of claim 3, wherein the fastening part comprises:
a pipe member having a shape extending upward toward the floor panel and having one side penetrating the battery part;
a bolt member inserted into the pipe member and having one end facing the battery part and another end penetrating the reinforcement member; and
a nut member fastened to the other end of the bolt member.

5. The structure of claim 4, wherein the battery part comprises a battery cross member provided on an upper surface of the battery part and having a shape protruding upward, and
wherein the pipe member is fixedly coupled to the battery cross member.

6. The structure of claim 4, wherein the nut member is provided to penetrate the floor panel and the reinforcement member.

7. The structure of claim 6, wherein the nut member is tightly attached to the reinforcement member and spaced apart from the floor panel.

8. The structure of claim 6, wherein the nut member is tightly attached to the reinforcement member and the floor panel.

9. The structure of claim 1, wherein the vehicle body member comprises a vehicle body cross member having a shape recessed upward when the vehicle body member is viewed from below, and wherein the fastening part faces the vehicle body cross member.

10. The structure of claim 1, wherein the vehicle body member comprises a vehicle body cross member having a shape recessed upward when the vehicle body member is viewed from below, and wherein the fastening part is spaced apart from the vehicle body cross member in a horizontal direction.

11. The structure of claim 1, wherein the floor panel and the reinforcement member are fixedly coupled directly to each other.

12. The structure of claim 1, wherein the floor panel, the vehicle body member, and the reinforcement member are fixedly coupled to one another in at least one region.

13. The structure of claim 12, wherein:
the vehicle body member comprises a vehicle body cross member having a shape recessed upward when the vehicle body member is viewed from below;
the floor panel, the vehicle body member, and the reinforcement member are fixed to one another in at least one region; and
the at least one region is spaced apart, in a horizontal direction, from a section of the vehicle body cross member recessed upward.

14. The structure of claim 1, wherein the reinforcement member includes a recessed section recessed downward, and the fastening part penetrates the recessed section of the reinforcement member.
